(19) United States
(12) Patent Application Publication
(10) Pub. No.: US 2021/0402563 A1
(43) Pub. Date: Dec. 30, 2021

(54) CONDITIONER DISK FOR USE ON SOFT OR 3D PRINTED PADS DURING CMP

(71) Applicant: Applied Materials, Inc., Santa Clara, CA (US)

(72) Inventors: Periya Gopalan, San Jose, CA (US); Allen L. D`Ambra, Burlingame, CA (US); Kieran J. Rynne, Kilcock (IE)

(21) Appl. No.: 17/353,193

(22) Filed: Jun. 21, 2021

Related U.S. Application Data
(60) Provisional application No. 63/045,017, filed on Jun. 26, 2020.

(51) Int. Cl. B24B 53/017; B33Y 80/00

(52) U.S. Cl. CPC B24B 53/017; B33Y 80/00

(57) ABSTRACT

A conditioner disk for use on a polishing pad during chemical mechanical polishing process includes a backing plate having a lower surface and abrasive diamond particles secured to the lower surface of the backing plate, the abrasive diamond particles disposed in a pattern that defines multiple channels for fluid flow.

### CROSS-REFERENCE TO RELATED APPLICATIONS

This application claims priority to U.S. Application Ser. No. 63/045,017, filed on Jun. 26, 2020, the disclosure of which is incorporated by reference.

### TECHNICAL FIELD

The present disclosure relates to chemical mechanical polishing (CMP), and more specifically to a conditioner disk for use in chemical mechanical polishing.

### BACKGROUND

Integrated circuits are typically formed on substrates, particularly silicon wafers, by the sequential deposition of conductive, semiconductive or insulative layers. After each layer is deposited, the layer is etched to create circuitry features. As a series of layers are sequentially deposited and etched, the outer or uppermost surface of the substrate, i.e., the exposed surface of the substrate, becomes successively less planar. This non-planar outer surface presents a problem for the integrated circuit manufacturer as a non-planar surface can prevent proper focusing of the photolithography apparatus. Therefore, there is a need to periodically planarize the substrate surface to provide a planar surface.

Chemical mechanical polishing is one accepted method of planarization. This planarization method typically requires that the substrate be mounted on a carrier or polishing head, with the surface of the substrate to be polished exposed. The substrate is then placed against a rotating polishing pad. The carrier head may also rotate and/or oscillate to provide additional motion between the substrate and polishing surface. Further, a polishing liquid, typically including an abrasive and at least one chemically reactive agent, may be spread on the polishing pad.

When the polisher is in operation, the pad is subject to compression, shear and friction producing heat and wear. Slurry and abraded material from the wafer and pad are pressed into the pores of the pad material and the material itself becomes matted and even partially fused. These effects, sometimes referred to as “glazing,” reduce the pad's roughness and ability to apply fresh slurry to the substrate. It is, therefore, desirable to condition the pad by removing trapped slurry, and unmatting, re-expanding or re-roughening the pad material. The pad can be conditioned after each substrate is polished, or after a number of substrates are polished. The pad can also be conditioned at the same time substrate are polished.

### SUMMARY

In one aspect, a conditioner disk for conditioning of a polishing pad has a backing plate having a lower surface, and abrasive diamond particles secured to the lower surface of the backing plate. The abrasive diamond particles are disposed in a pattern that defines multiple channels for fluid flow.

In another aspect, a conditioner disk for conditioning of a polishing pad has a backing plate having a lower surface, and abrasive diamond particles secured to the lower surface of the backing plate in a plurality of regions. The abrasive diamond particles are substantially rectangular solid in shape and have a mean diameter of 150-180 μm and a standard deviation less than 40 μm.

One or more of the following possible advantages may be realized. The conditioner disk can abrade a soft or 3D printed polishing pad with sufficient high aggressiveness to avoid glazing and provide wafer-to-wafer uniformity, but with sufficiently low aggressiveness so as to maintain a reasonable pad life. The polishing pad includes a abrasive surface area that can cut a pad uniformly and smoothly. This abrasive surface area can be selected based on other polishing process conditions, e.g., modulus of the polishing pad or viscosity of the polishing liquid, to optimize various polishing parameters, e.g., polishing liquid distribution. Slurry build-up on the bottom surface of the conditioning disk can be avoided, thus reducing the risk of coagulation and defects. The conditioner disk can also have a longer life than conventional conditioner disks.

The details of one or more implementations are set forth in the accompanying drawings and the description below. Other aspects, features, and advantages will be apparent from the description and drawings, and from the claims.

### BRIEF DESCRIPTION OF THE DRAWINGS

FIG. 1A is a schematic cross-sectional side view of a polishing station.

FIG. 1B is a schematic perspective view of a conditioner head placed on a polishing pad for conditioning the polishing pad with a conditioner disk.

FIG. 2A-B each illustrate an example implementation of a conditioner disk that includes abrasive diamond particles disposed in a pattern that defines multiple channels for fluid flow.

FIG. 3 is a schematic cross-sectional side view of an example implementation of a conditioner disk.

### DETAILED DESCRIPTION

Typically, chemical mechanical polishing processes include an in-situ pad conditioning step in which a conditioner disk, e.g., a disk coated with abrasive diamond particles, is pressed against the rotating polishing pad to condition and texture the polishing pad surface. A conventional conditioner disk, however, can abrade a soft or 3D printed polishing pad with excessive aggressiveness. The higher wear rate of the pad thus shortens the pad life. In addition, the conditioner disk may not cut into the surface of the soft or 3D printed polishing pad evenly, which creates a differential in surface roughness across the polishing surface, which can lead to polishing rate non-uniformity.

Another issue is the flow of polishing liquid below the conditioner. The conditioner disk can affect distribution of the polishing liquid, but the specific effect also depends on properties such viscosity and/or density of the polishing liquid, e.g., the abrasive slurry, which can vary between different polishing processes. In addition, abrasive particles in the polishing liquid can accumulate on the conditioner disk, and can coagulate to form larger aggregates that can cause scratching and defects.

A technique that may address one or more of these issues is to have a conditioner disk coated with abrasive diamond particles arranged in a pattern which effectively defines abrasive surface area of the conditioner disk. By using a conditioner disk with a patterned abrasive surface area that can cut a polishing pad modestly and uniformly, a reasonable pad life, and consistent polishing performance, e.g., as measured by within-wafer non-uniformity or wafer-to-wafer non-uniformity, can be maintained. The pattern can also improve the polishing liquid flow out from beneath the conditioner, thus preventing slurry build-up and reducing the risk of defects. Moreover, the pattern can be customized based on the properties of the polishing pad and polishing liquid to be used in the polishing process to provide a desired wear rate of the pad and flow pattern of the polishing liquid.

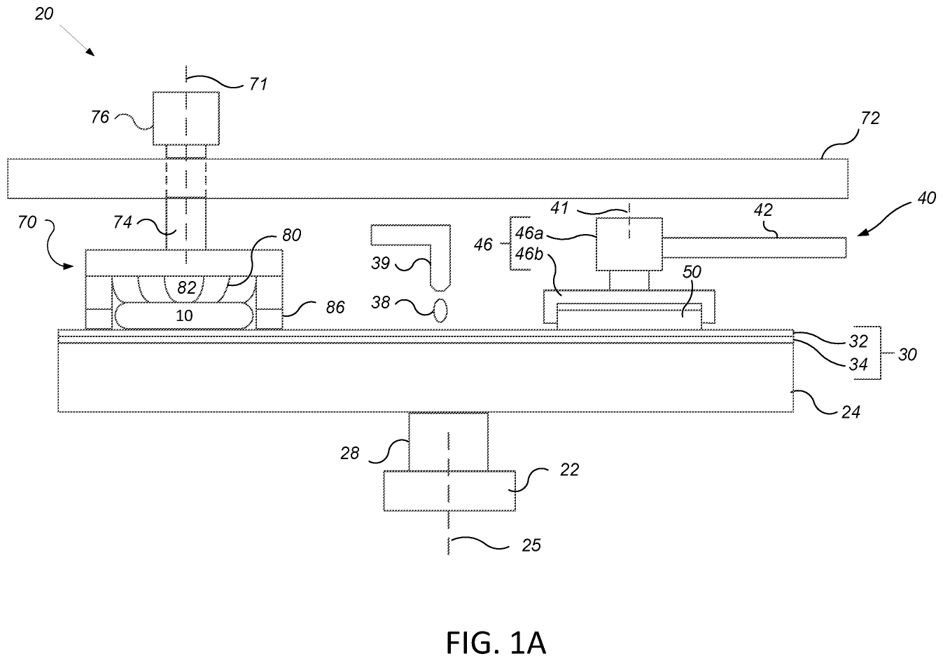

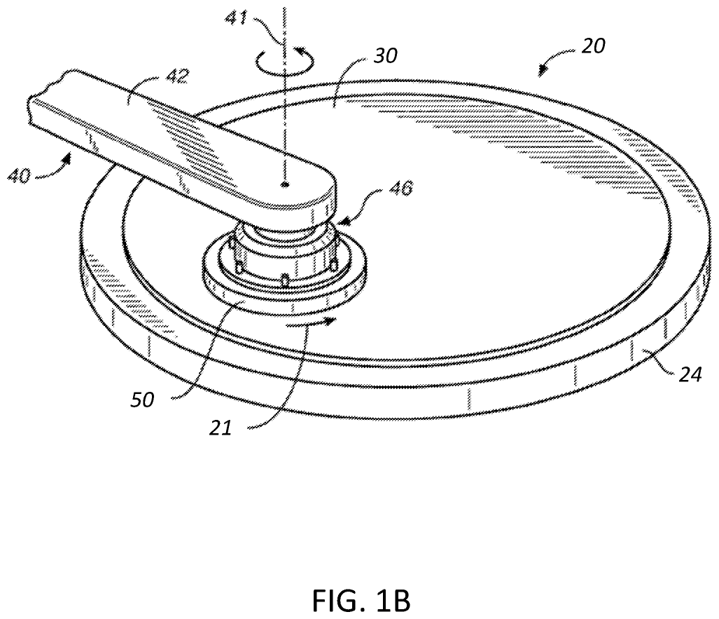

As shown in FIGS. 1A and 1B, the polishing station 20 of chemical mechanical polishing (CMP) apparatus includes a rotatable disk-shaped platen 24, which supports a polishing pad 30, and a carrier head 70 to hold a substrate 10 against the polishing pad 30. Although unillustrated, the CMP apparatus can include multiple polishing stations.

For example, the polishing pad 30 can be a two-layer polishing pad with an outer layer 34 and a softer backing layer 32. In some cases, the polishing pad 30 can be a soft pad or a 3D printed pad. That is, the construction materials of the polishing pad 30 can include soft materials or 3D printing materials. The polishing pad can have a hardness of 40 to 80 Shore A.

The platen 24 is operable to rotate about an axis 25. For example, a motor 22 can turn a drive shaft 28 to rotate the platen 24.

The carrier head 70 is suspended from a support structure 72, e.g., a carousel or a track, and is connected by a drive shaft 74 to a carrier head rotation motor 76 so that the carrier head can rotate about an axis 71. Optionally, the carrier head 70 can oscillate laterally, e.g., on sliders on the carousel or track 72; or by rotational oscillation of the carousel itself. In operation, the platen is rotated about its central axis 25, and the carrier head is rotated about its central axis 71 and translated laterally across the top surface of the polishing pad 30. Where there are multiple carrier heads, each carrier head 70 can have independent control of its polishing parameters, for example each carrier head can independently control the pressure applied to each respective substrate.

The carrier head 70 can include a flexible membrane 80 having a substrate mounting surface to contact the back side of the substrate 10, and a plurality of pressurizable chambers 82 to apply different pressures to different zones, e.g., different radial zones, on the substrate 10. The carrier head can also include a retaining ring to hold the substrate.

The polishing station 20 can include a supply port or a combined supply-rinse arm 39 to dispense a polishing liquid 38, such as slurry, onto the polishing pad 30.

The polishing station 20 also includes a pad conditioner 40. The pad conditioner 40 includes a conditioner head 46, an unillustrated base, and an arm 42 connecting the conditioner head 46 to the base. The base can pivot to sweep the arm 42 and the conditioner head 46 across a surface of the polishing pad 30.

The polishing station 20 can also include a cleaning cup, which contains a cleaning liquid for rinsing or cleaning the conditioner head 46. The arm 42 can move the conditioner head 46 out of the cleaning cup and place the conditioner head 46 atop the polishing pad 30.

The conditioner head 46 includes a conditioner disk 50 that is brought into contact with the polishing pad 30. The conditioner disk 50, which will be discussed in detail below, is generally positioned at a bottom of the conditioner head 46 and can rotate around an axis 41. A bottom surface of the conditioner disk 50 includes abrasive regions that contact the surface of the polishing pad 30 during the conditioning process. During conditioning, both the polishing pad 30 and the conditioning disk 50 rotate, so that these abrasive regions move relative to the surface of the polishing pad 30, thereby abrading and retexturizing the surface of the polishing pad 30.

The conditioner head 46 includes mechanisms to attach the conditioner disk 50 to the conditioner head 46 (such as mechanical attachment systems, e.g., bolts or screws, or magnetic attachment systems) and mechanisms to rotate the conditioner disk 50 around the rotating axis 41 (such as drive belts through the arm or rotors inside the conditioner head). In addition, the pad conditioner 40 can also include mechanisms to regulate the pressure between the conditioner disk 50 and the polishing pad 30 (such as pneumatic or mechanical actuators inside the conditioning head or the base). For example, the conditioner head 46 can include an upper portion 46a, a lower portion 46b that holds the condition disk 50, and an actuator to adjust the vertical position of the lower portion 46b relative to the upper portion 46a or to adjust the pressure of the conditioner disk 50 on the polishing pad 30. However, these mechanisms can have many possible implementations (and are not limited to those shown in FIG. 1).

During conditioning, the conditioning disk 50 is moved into contact with the polishing pad 30 and rotated in a predefined direction 21. The predefined direction may be counter-clockwise or clockwise as viewed from a top side of the polishing station 20.

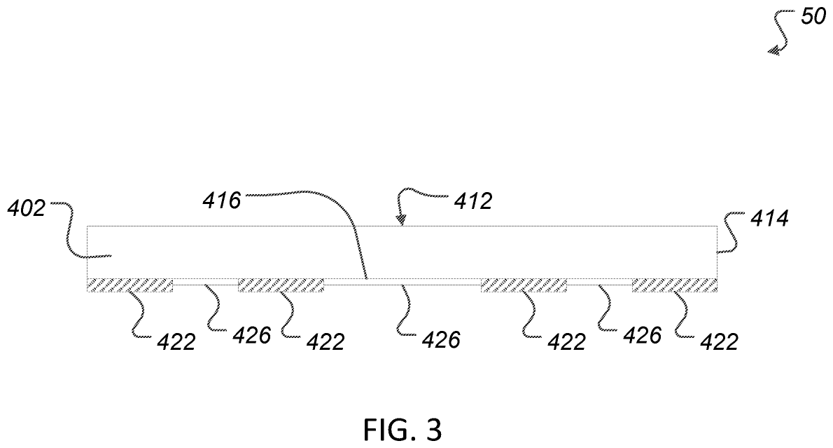

Referring to FIG. 3, the conditioner disk 50 includes a backing plate 402 in the form of a generally planar disk. The backing plate 402 has an upper surface 412 that can contact the conditioner head 46 and a lower surface 416. The backing plate 402 can be a durable rigid material, e.g., a metal, such as stainless steel, or a ceramic.

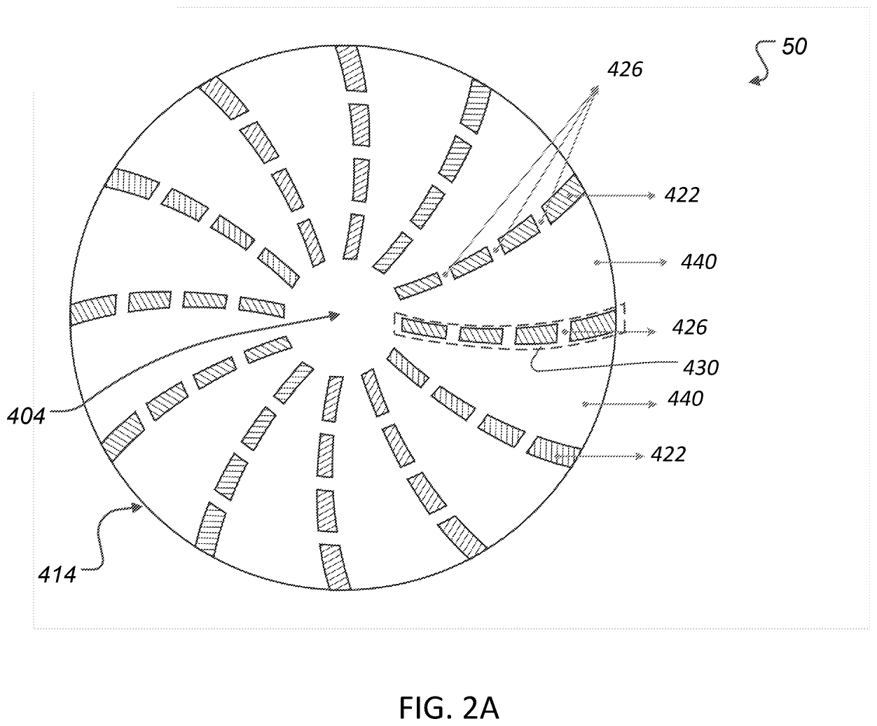

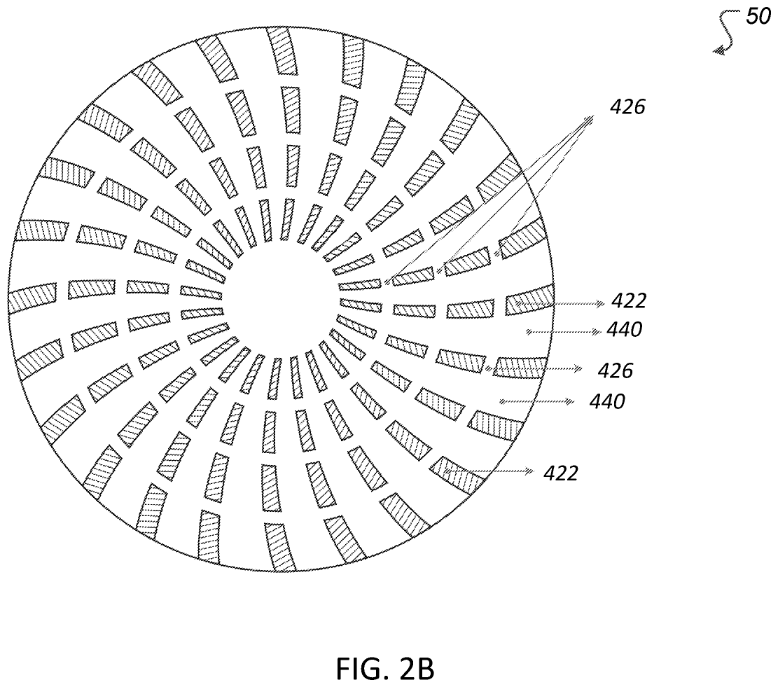

The conditioner disk 50 has a plurality of abrasive regions 422 in which abrasive diamond particles are secured to the lower surface 416 of the backing plate 402. In some implementations, abrasive particles of other compositions, e.g., silicon carbide, can be used instead of or in addition to diamond particles. As will be described in more detail below with reference to FIGS. 2A-B, the abrasive regions are arranged in a pattern on the lower surface 416.

The abrasive diamond particles are disposed on the backing plate to provide a structure capable of removing (e.g., cutting, polishing, scraping) material from a polishing pad. Each individual abrasive diamond particle can have one or more cutting points, ridges or mesas. In some implementations, the abrasive diamond particles are substantially rectangular solid in shape. Such “blocky” abrasive particles can provide superior conditioning of the material used in 3D printed polishing pads, e.g., a low wear rate while maintaining uniform surface roughness across the pad, as compared to other shapes such as jagged, octahedral, etc. In some implementations, the abrasive diamond particles are 125-250 μm in size. In some implementations, the diamond abrasive particles have a mean diameter of 140-200 μm, e.g., 150-180 μm, and a standard deviation less than 40 μm, e.g., less than 30 μm, e.g., less than 20 μm, e.g., less than 10 μm. This size range can provide superior conditioning of the material used in 3D printed polishing pads, e.g., a low wear rate while maintaining uniform surface roughness across the pad.

The abrasive diamond particles can be fixed to the lower surface 416 of the backing plate 402 by a variety of techniques. For example, the abrasive diamond particles can be attached to the lower surface 416 by way of known electroplating and/or electrodeposition processes. As another example, the abrasive diamond particles can be attached to the lower surface 416 by way of organic binding, brazing or welding processes.

Typically, abrasive diamond particle are not adhered to an edge 414 of the backing plate 402. The edge 414 can be in the form of a right angle or sharp edge. The edge 414 can also be modified, e.g., chamfered, to make the edge 414 more compatible with the conditioning process required for different types of polishing pad material.

The conditioner disk 50 also has a polymer coating 426 covering exposed areas of the lower surface 416, i.e., areas that are not covered by the abrasive regions 422. For example, the polymer coating 426 can include a polyamide. The polymer coating 426 increases the hydrophobicity of the lower surface 416. A hydrophobic lower surface on the conditioner disk 50 can impede the polishing liquid from sticking to the conditioner disk 50 as the pad conditioning process proceeds, and thus can reduce the likelihood of particle agglomeration and defect.

The exact thickness of the abrasive regions 422 and the polymer coating 426 may vary, but the abrasive regions 422 can be thicker than the polymer coating 426 such that the polymer coating 426 does not directly impact the polishing pad when the conditioning disk 50 is moved into contact with the polishing pad and rotated in a predefined direction 21. This effectively reduces abrasive surface area of the conditioning disk 50, e.g., compared to a conventional disk with a uniformly abrasive surface. The reduced abrasive surface area results in less abrasion, which in turn reduces wear rate of the polishing pad.

The pattern of abrasive regions 430 across the lower surface 416 of the conditioner disk 50 can be designed to optimize various conditioning procedures.

For example, the total surface area of the abrasive region can be selected to adapt to different types of polishing pad material. FIG. 2A illustrates an example implementation of a conditioner disk 50 that is customized for a soft or 3D printed polishing pad. Briefly, in this example, the conditioner disk 50 is coated with a reduced abrasive surface area, e.g., a reduced number of abrasive diamond particles, as compared to a conditioner disk of the same size that that is uniformly coated with abrasive diamond particles. The reduced abrasive surface area reduces conditioning aggressiveness so as to maintain a reasonable pad life.

As shown in the implementation of FIG. 2A, a plurality of abrasive regions 422 extend in a generally radial direction on the lower surface of the backing plate of the conditioner disk 50. In particular, the abrasive regions 422 form radially extending “arms” 430 that radiate outwardly from the center region 404 (into which the abrasive regions do not extend) to the edge 414 of the conditioner disk 50. Each arm 430 can be curved, e.g., form an arc or a portion of a spiral. The arms 430 can curve in a common direction. The common direction can be, but need not be, the same as the predefined direction in which the conditioning disk 50 rotates. Each arm 430 can be extend across an arc of, e.g., 15-45°, between the center and edge of the conditioner disk. All of the arms 430 can be identical in shape.

The arms 430 may be distributed at regularly spaced angular intervals about the axis of rotation. All of the angular intervals can be equal to each other, or the angular intervals can have different sizes. The space between each pair of circumferentially adjacent arms 430 can form a channel 440. Assuming the abrasive regions 422 maintain a generally consistent width along the length of the arm 430, the channel 440 is narrower near the center region 404 than at the edge 414 of the conditioner disk 50. The channel 440 extends generally in a radial direction on the lower surface of the conditioner disk 50. In this way, the plurality of arms 430 define multiple radial channels for fluid flow. As described above with reference to FIG. 3, the multiple radial channels 440 are covered by a polymer coating which provides hydrophobicity. The exact numbers of channels may vary between different implementations, but typically, each conditioner disk can have 8-40 such channels.

When the conditioner disk 50 rotates in the same direction as the direction in which the arms 430 are curved and the arms contact a surface of the polish pad, the channels 440 between circumstantially adjacent arms may capture fluid in an area near a periphery of the conditioner disk 50 and direct the captured slurry to the center region 404.

When the conditioner disk rotates opposite to the direction in which the arms 430 are curved and the arms contact a surface of the polish pad, the channels 440 between circumstantially adjacent arms may expel slurry from the center region 404 and directs the expelled fluid to an area near the periphery of the conditioner disk. For some slurry compositions, e.g., slurries using cerium oxide particles, the slurry can stick to the conditioner disk even if a non-wetting coating, e.g., the polymer coating, is present on the channels. However, the channels 440 can help expel the slurry to prevent build-up of slurry and reduce scratching or other defects.

The arms 430 can be divided into individual segments, provided by the individual abrasive regions 422, by gaps 426. These segments, i.e., the individual regions 422 along an arm 430, can also be distributed at regularly spaced radial intervals from the axis of rotation. All of the segments 422 can be identical in shape, or the segments 422 can have different shapes. All of the gaps 426 can have equal radial lengths, or the gaps 426 can have different sizes. Every pair of radially adjacent segments of the plurality of segments may form a channel that approximately runs a length of a side (e.g., width) of the segment. In this way, the plurality of abrasive segments also define multiple tangential channels for fluid flow on the lower surface of the conditioner disk 50. The multiple tangential channels permit fluid to flow between the radial channels when the conditioner disk 50 rotates in either direction. The multiple tangential channels are similarly covered by a polymer coating which provides hydrophobicity.

Thus, polishing liquid build-up can be largely prevented by the multiple fluid flow channels that are defined by the abrasive pattern, together with the polymer coating of the channels which provides hydrophobicity. This reduces the possibility that accumulated dry polishing liquid could fall onto the polishing pad and scratch a wafer undergoing polishing.

As another example, the angular spacing between circumstantially adjacent abrasive diamond particle segments can be carefully selected to aid in, or better control, the flow of various fluids (e.g., polishing liquid) around and through the abrasive segments to increase the efficacy and efficiency of the material removing process. FIG. 2B illustrates an example implementation of a conditioner disk that is customized for CMP processes that make use of highly viscous polishing liquids. Briefly, in this example, the segments 422 are placed at narrower angular intervals and collectively define nearly twice as many channels 440 for fluid flow that extend generally in a radial direction, i.e., compared to the example implementation of FIG. 2A. In operation, the additional channels can more effectively repel polishing liquids from the conditioner disk 50.

A number of embodiments of the invention have been described. Nevertheless, it will be understood that various modifications may be made. Accordingly, other embodiments are within the scope of the following claims.

What is claimed is:

1. A conditioner disk for conditioning of a polishing pad, comprising:
a backing plate having a lower surface; and
abrasive diamond particles secured to the lower surface of the backing plate, the abrasive diamond particles disposed in a pattern that defines multiple channels for fluid flow.

2. The conditioner disk of claim 1, further comprising a polymer coating covering the lower surface in the channels to provide hydrophobicity.

3. The conditioner disk of claim 1, wherein the abrasive diamond particles are substantially rectangular solid in shape.

4. The conditioner disk of claim 1, wherein the abrasive diamond particles are between 125 μm to 250 μm in size.

5. The conditioner disk of claim 4, wherein the diamond abrasive particles have a mean diameter of 150-180 μm.

6. The conditioner disk of claim 5, wherein the diamond abrasive particles have a standard deviation in diameter less than 40 μm.

7. The conditioner disk of claim 1, wherein the pattern comprises regions radially extending from a center of the lower surface of the backing plate and gaps between the regions that define the multiple channels.

8. The conditioner disk of claim 7, wherein the regions radially extending from the center of the lower surface of the backing plate form multiple spirals.

9. The conditioner disk of claim 8, wherein each spiral extends across an arc of at least 10°.

10. The conditioner disk of claim 9, wherein each spiral extends through an arc of 15°-45°.

11. The conditioner disk of claim 8, wherein the multiple channels comprise 8 to 40 channels.

12. The conditioner disk of claim 8, wherein each radially extending region is broken by one or more gaps that provide radial separation between radially extending region.

13. A conditioner disk for conditioning of a polishing pad, comprising:
a backing plate having a lower surface; and
abrasive diamond particles secured to the lower surface of the backing plate in a plurality of regions, the abrasive diamond particles being substantially rectangular solid in shape and having a mean diameter of 150-180 μm and a standard deviation less than 40 μm.

14. The conditioner disk of claim 13, wherein the particles are secured by brazing.

15. The conditioner disk of claim 13, wherein the regions are disposed in a pattern that defines multiple radially extending channels for fluid flow.

16. A method of chemical mechanical polishing, comprising:
bringing a substrate into contact with a polishing pad; and
conditioning the polishing pad using a conditioning disk that includes a backing plate having a lower surface and abrasive diamond particles secured to the lower surface of the backing plate, wherein the abrasive diamond particles are disposed in a pattern that defines multiple channels for fluid flow.

17. The method of claim 16, wherein the polishing pad has a hardness of 50 to 80 Shore A.

18. The method of claim 16, wherein the polishing pad comprises a 3D printed pad.

19. The method of claim 16, comprising delivering a polishing liquid to the polishing pad.

20. The method of claim 19, wherein the polishing liquid comprises a cerium oxide slurry.
